(19) United States
(12) Patent Application Publication
(10) Pub. No.: US 2004/0093583 A1
(43) Pub. Date: May 13, 2004

(54) Project bidding system

(76) Inventors: Brian T. McAnaney, Stamford, CT (US); Joseph J. Ringhoffer, Trumbull, CT (US); Rajeev Lakra, Weston, CT (US)

Correspondence Address: BUCKLEY, MASCHOFF, TALWALKAR LLC, 5 ELM STREET, NEW CANAAN, CT, 06840, US

(21) Appl. No.: 10/293,110

(22) Filed: Nov. 13, 2002

(51) Int. Cl. G06F 9/44

(52) U.S. Cl. 717/103; 717/104

(57) ABSTRACT

A project bidding system includes a modular bidding toolkit for facilitating bid solicitation and evaluation. The toolkit provides a bid template for specifying bidding parameters for a project, a terms and conditions document, a provider engagement letter, and a provider policy. The bid template may allow association of a project with a first number of work hours and a first billing rate for a first provider level, and with a second number of work hours and a second billing rate for a second provider level, and reception of a plurality of bids for the project from the plurality of potential bidders, one or more of the plurality of bids including a third billing rate for the first provider level and a fourth billing rate for the second provider level.

### BACKGROUND

1. Field

The present invention relates to systems for use in project bidding. More specifically, the present invention concerns, in some aspects, systems for soliciting and/or evaluating project bids.

2. Discussion

Businesses and individuals must often engage outside entities to complete desired projects. These projects may comprise any of countless services, including business consulting, legal service, accounting service, computer system installation, and construction. Competitive bidding is one system that is conventionally used to select and hire such outside entities.

According to some competitive bidding systems, the hiring entity creates a Request For Quote (RFQ) that describes a desired project. The RFQ is forwarded to several outside entities who are believed to be capable of completing the project. Each outside entity prepares a bid based on the RFQ and returns the bid to the hiring entity. The bids are evaluated by the hiring entity and a winning bid is selected. Selection of the winning bid takes into account not only a quoted price, but also other planning and execution details set forth in the bids.

Some companies currently offer systems that allow hiring entities to solicit bids from legal service providers. For example, FeeBid.com™ receives a description of a legal project from a hiring entity, generates an RFQ including a price estimate, and forwards the RFQ to legal service providers. According to other systems, such as that provided by LawyersForLess™, bidding legal service providers to specify different billing rates for different attorneys who would provide the desired legal project.

Neither of these or other current systems allow legal service providers to provide bids that are adequately descriptive and/or easily comparable to one another. Moreover, existing systems do not allow hiring entities to efficiently solicit, select, and/or administer a winning bid.

### BRIEF DESCRIPTION

In order to address the foregoing, some embodiments of the invention include a modular toolkit having a bid template for specifying bidding parameters for a project, a terms and conditions document, a provider engagement letter, and a provider policy. According to some aspects, the bid template includes a first area for indicating, for a first project, a first number of work hours and a first billing rate for a first provider level, and a second area for indicating, for the first project, a second number of work hours and a second billing rate for a second provider level.

Embodiments of the present invention may also concern a system, a method, an apparatus, a computer-readable medium storing processor-executable process steps, and means to associate a project with a first number of work hours and a first billing rate for a first provider level, and with a second number of work hours and a second billing rate for a second provider level, to transmit the associations to a plurality of potential bidders, and to receive a plurality of bids for the project from the plurality of potential bidders, one or more of the plurality of bids including a third billing rate for the first provider level, and a fourth billing rate for the second provider level.

In other aspects, the present invention provides for reception of a plurality of bids and determination of a winning bid from the plurality of bids based on a total blended billing rate, historical billing rates of a single bidder, and/or historical billing rates of two or more bidders.

In still other aspects, some embodiments of the present invention provide a billing template including a first area for indicating, for a first project, a first number of work hours and a first billing rate for a first provider level, and a second area for indicating, for the first project, a second number of work hours and a second billing rate for a second provider level.

A technical content of some embodiments of the invention includes at least one or more of the use of computing devices to create bid templates, to define projects, to submit bids and to evaluate bids. With this and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a topographic view of a network architecture according to some embodiments of the present invention.

FIG. 2 is a block diagram of an internal architecture of a requester device according to some embodiments to the present invention.

FIG. 3 is a block diagram of an internal architecture of a bidding management device according to some embodiments to the present invention.

FIG. 4 is a block diagram of an internal architecture of a bidder device according to some embodiments to the present invention.

FIG. 5 is a representative view of a tabular portion of a template database according to some embodiments of the present invention.

FIG. 6 is a representative view of a tabular portion of a fee database according to some embodiments of the present invention.

FIG. 7 is a representative view of a tabular portion of a client template database according to some embodiments of the present invention.

FIG. 8 is a representative view of a tabular portion of a bidder database according to some embodiments of the present invention.

FIG. 9 is a representative view of a tabular portion of a bid database according to some embodiments of the present invention.

FIG. 10 is a flow diagram of process steps according to some embodiments of the present invention.

FIGS. 11A and 11B comprise a view of a bid template according to some embodiments of the present invention.

FIG. 12 comprises a view of a bid template completed by a bidder according to some embodiments of the present invention.

FIG. 13 comprises a view of a bid comparison worksheet according to some embodiments of the present invention.

FIG. 14 comprises a view of a bid template according to some embodiments of the present invention.

FIG. 15 comprises a view of a bid template completed by a bidder according to some embodiments of the present invention.

FIG. 16 comprises a view of a bid comparison worksheet according to some embodiments of the present invention.

### DETAILED DESCRIPTION

According to some embodiments, a modular toolkit is provided to facilitate project bidding. The toolkit may include a bid template, a terms and conditions document, a provider engagement letter, and a provider policy. These toolkit elements may be used to facilitate execution of an auction for legal and/or other services. In one embodiment, an entity requesting bids may use the bid template to indicate a first number of work hours and a first billing rate for a first provider level, and a second number of work hours and a second billing rate for a second provider level. A bidder, in turn, uses the template to indicate a first bid billing rate for the first provider level and a second bid billing rate for the second provider level. As a result, the requesting entity may compare received bids according to individual billing rates or various combinations and weightings of billing rates. Further details of bid templates, toolkit elements and auction procedures according to some embodiments will be described in detail below.

### System Architecture

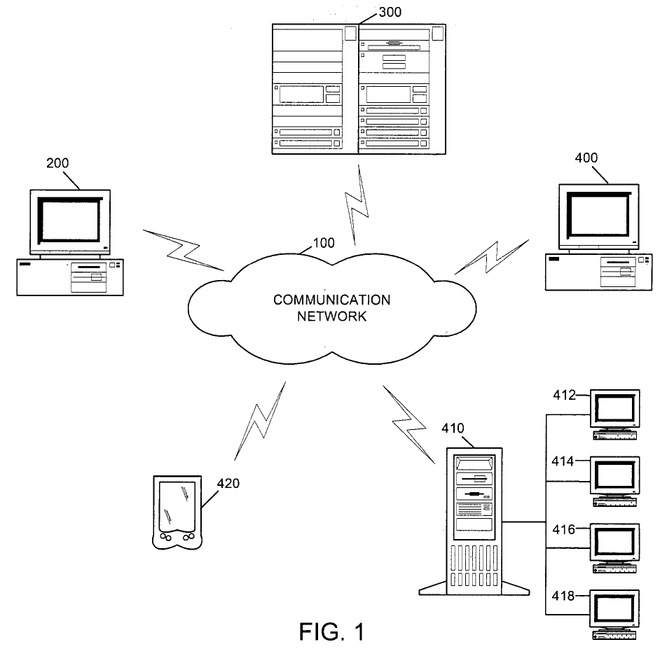

FIG. 1 illustrates a network architecture of a system to implement an auction toolkit according to some embodiments of the present invention. As shown, communication network 100 provides communication between requester device 200, bidding management device 300 and bidder devices 400 through 420. Embodiments of the invention may be computer-implemented to various degrees, and some embodiments may be entirely paper-based.

Communication network 100 may comprise any number of different systems for transferring data, including a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11b standard), a Bluetooth network, an infrared network, and/or an IP network such as the Internet, an intranet or an extranet. As used herein, the term “communication” can refer to wired and/or wireless communication as appropriate.

Requestor device 200 is depicted as a desktop computer in FIG. 1, but may comprise any type of device or devices suitable for performing the steps attributed to requestor device 200 below. Requestor device 200 may interface with communication network 100 directly or over one or more networks. Requestor device 200 may be operated by any entity that wishes to receive bids for a particular project. In the examples that follow, the entity operating requester device 200 comprises a business representative who is soliciting bids to provide legal services. It should be noted that some embodiments of the present invention are not limited to this type of project.

In some embodiments, requester device 200 provides its operator with the ability to manage aspects of project bidding. As will be described in detail below, this ability may include the ability to associate a project with a first number of work hours and a first billing rate for a first provider level, and with a second number of work hours and a second billing rate for a second provider level, to transmit the associations to a plurality of potential bidders, and to receive a plurality of bids for the project from the plurality of potential bidders, one or more of the plurality of bids including a third billing rate for the first provider level, and a fourth billing rate for the second provider level. In some embodiments, the billing rates are fixed and the number of work hours are guidelines to be considered by potential bidders.

This ability may also allow access and deployment of elements of a modular toolkit such as one or more terms and conditions documents, engagement letters and provider policies. These elements may facilitate engagement, management, and termination of a relationship with a service provider. The terms “documents” and “letters” may be construed to include any system or device to communicate information, including but not limited to paper documents, electronic transmissions and aural communication. In this regard, a paper bid template may be used to associate a project with a first number of work hours and a first billing rate for a first provider level, and with a second number of work hours and a second billing rate for a second provider level.

Bidding management device 300 comprises a mainframe server. In some embodiments, bidding management device 300 receives completed bid templates from requestor device 200, transmits the templates to designated bidders, receives bids from the bidders and transmits the bids to requestor device 200. In some embodiments, bidding management device 300 also or alternatively receives and transmits paper bids and/or bid templates. Bidding management device 300 may be operated by the same entity that operates requestor device 200, or by another entity. A third-party provider of procurement services, such as Procuri™ and SourceBid™, operates device 300 in accordance with some embodiments. As such, bidding management device 300 may provide procurement services to more than one requesting entities. Bidding management device 300 may present a Web-based interface to requesters and bidders, thereby enabling the submission of completed templates, submission of bids, and retrieval of bids via a Web browser.

In this regard, completed bid templates may be retrieved and bids may be submitted by one or more of bidder devices 400 through 420. Bidder devices 400 through 420 comprise a personal computer, a network server, and a personal digital assistant, respectively. Bidder device 410 operates to serve data and applications to network terminals such as bidder devices 412 through 418. One or more of bidder devices 400 through 420 may be operated by a representative of a service provider such as a law firm. Of course, user devices 400 through 420, as well as devices 200 and 300, may provide their respective operators with functionality unrelated to the present invention.

It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

In some embodiments, the devices of FIG. 1 are connected differently than as shown. For example, some or all of the devices may be connected directly to one another. Embodiments of the invention may include different, more or fewer devices that those shown. According to some embodiments, some or all of the toolkit elements are paper-based and the steps described herein are performed manually.

### Requestor Device

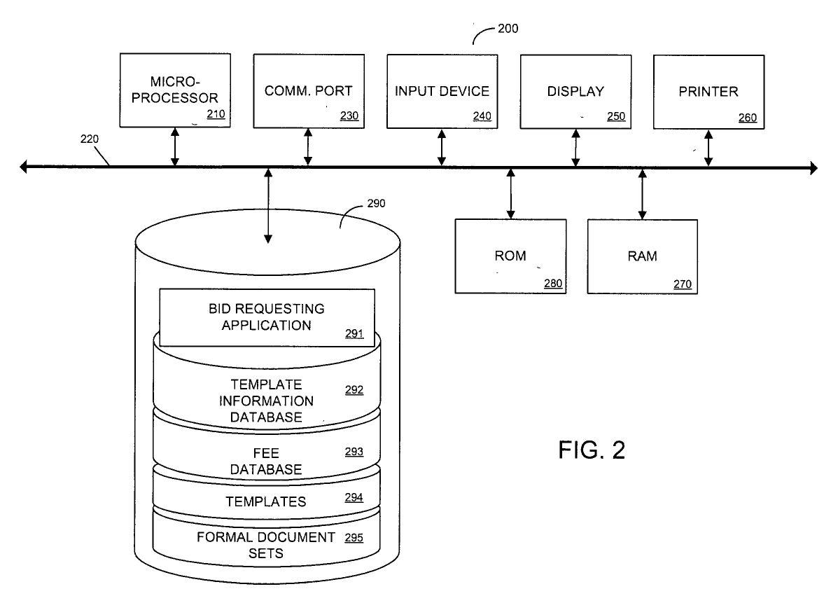

FIG. 2 is a block diagram of the internal components of requestor device 200 according to some embodiments of the invention. As illustrated, requestor device 200 includes microprocessor 210 in communication with communication bus 220.

Also in communication with communication bus 220 is communication port 230. Communication port 230 is used to transmit data to and to receive data from devices external to requestor device 200 such as peripheral devices and bidding management device 300. Communication port 230 is therefore preferably configured with hardware suitable to physically interface with desired external devices and/or network connections. For example, communication port 230 may comprise an Ethernet connection to a local area network through which requester device 200 may receive and transmit information over the Web.

Input device 240, display 250 and printer 260 are also in communication with communication bus 220. Any known input device may comprise input device 240, including a keyboard, mouse, touch pad, voice-recognition system, and any combination of these devices. Of course, information may also be input to requestor device 200 from other devices via communication port 230.

Display 250 may be an integral or separate CRT display, flat-panel display or the like used to display graphics and text in response to commands issued by microprocessors 210. Such graphics and text may comprise a bid template in accordance with some embodiments of the present invention. Printer 260 may also present text and graphics to an operator, but in hardcopy form using ink-jet, thermal, dot-matrix, laser, or other printing technologies.

RAM 265 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during boot-up of requester device 200 or to control communication port 230. It should be noted that one or both of RAM 270 and ROM 280 may communicate directly with microprocessor 210 instead of over communication bus 220.

Data storage device 290 stores, among other data, processor-executable process steps of bid requesting application 291. Microprocessor 210 therefore executes the process steps of bid requesting application 291 in order to control requestor device 200 to facilitate project bidding according to some embodiments of the present invention. For example, the process steps are executed in some embodiments to associate a project with a first number of work hours and a first billing rate for a first provider level, and with a second number of work hours and a second billing rate for a second provider level, to transmit the associations to a plurality of potential bidders, and to receive a plurality of bids for the project from the plurality of potential bidders, one or more of the plurality of bids including a third billing rate for the first provider level, and a fourth billing rate for the second provider level.

According to some embodiments, these associations are established by completing a bid template according to some embodiments. Such a bid template may be presented by display 250, completed using input device 240, and output using printer 260. The output template may be manually transmitted to potential bidders directly or through bidding management device 300. More automated embodiments include transmission of an electronic copy of the completed bid template to the bidders and/or bidding management device 300.

Bid requesting application 291 may also include process steps of a Web client that are executable to request and receive information from a Web server. The process steps of bid requesting application 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

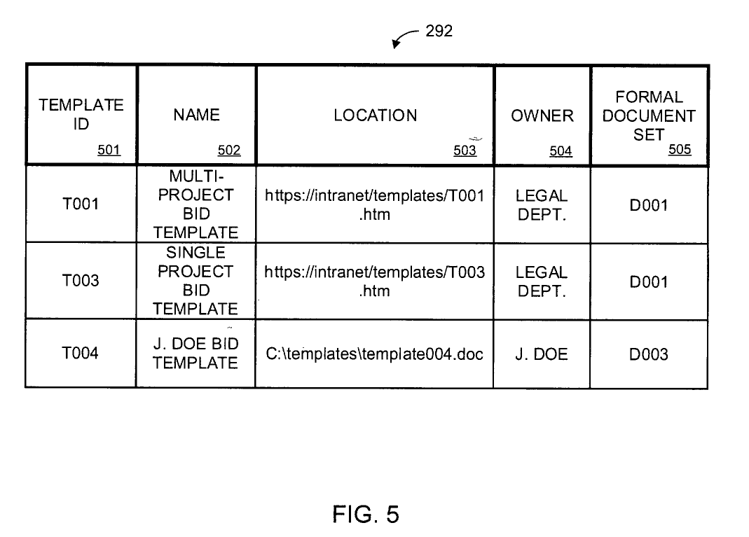

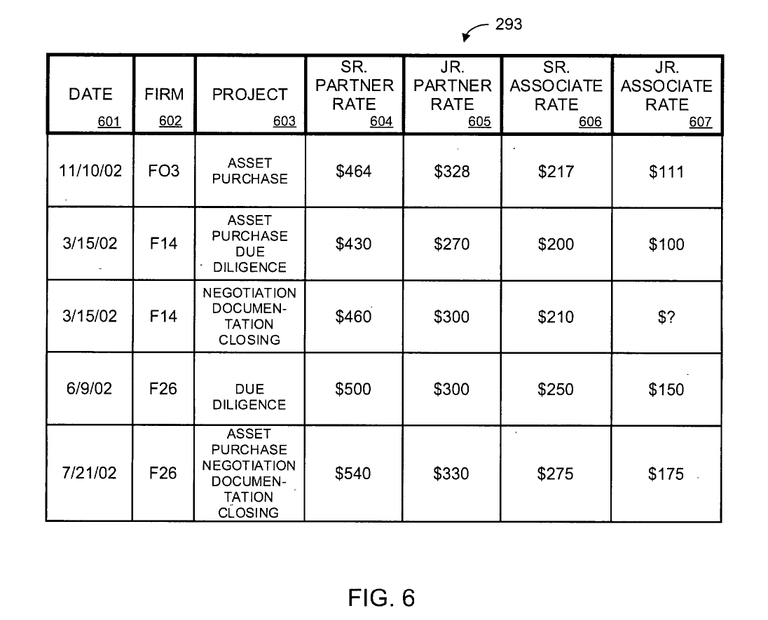

Data storage device 290 also stores template information database 292, fee database 293, templates 294 and formal document sets 295. Template information database 292 stores information relating to bid templates that are used by requester device 200, and fee database 293 includes information relating to fees that were previously-applied by or otherwise associated with specific service providers. Databases 292 and 293 will be described in more detail with respect to FIGS. 5 and 6. Templates 294 include the templates that are described in templates database 292, and formal document sets 295 include sets comprising one or more terms and conditions documents, provider engagement letters, provider policies, and cost-saving agreements. In some paper-based embodiments, bid templates and formal document sets are stored in paper format within in a physical file rather than in an electronic format among templates 294 and formal document sets 295.

Storage device 290 may also store one,or more of other applications, data files, device drivers and operating system files needed to provide functions related and unrelated to the present invention.

### Bidding Management Device

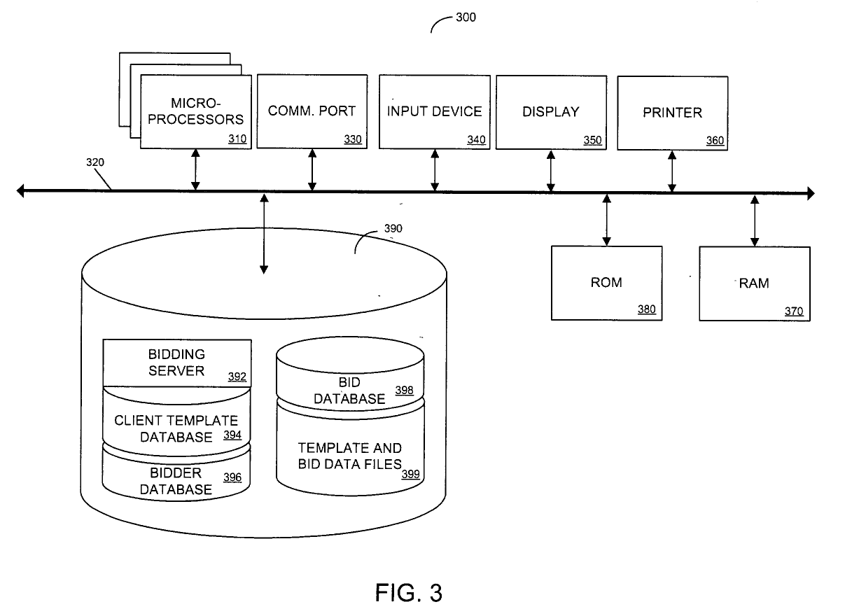

FIG. 3 is a block diagram illustrating components of bidding management device 300 according to some embodiments of the invention. It should be noted that these distinct components may comprise any of the specific examples given above with respect to identically-named components of requester device 200. Of course, specific functions performed by the components may differ from the functions performed by the identically-named components. For example, microprocessors 310 may comprise RISC-based and other types of processors and are used to execute processor-executable process steps so as to control the elements of bidding management device 300 to provide functionality described herein.

Data storage device 390 stores process steps of bidding server application 392. As generally described below, the process steps may be executed by microprocessors 310 to receive completed bid templates from requestor device 200, to transmit the completed bid templates to authorized bidders via bidder devices 400 through 420, to receive bids from bidder devices 400 through 420, and to transmit the bids to requester device 200.

Bidding server application 392 may include process steps of a Web server in order to facilitate the foregoing data exchanges with Web clients executed by devices 200 and 400 through 420. Microsoft Internet Information Server™ is one example of a suitable Web server. The Web server may provide communication via a secure protocol such as secure hypertext transfer protocol (HTTPS). HTTPS is a communications protocol designed to transfer encrypted information between computers over the World Wide Web. Generally the HTTPS protocol is equivalent to a combination of the more-common HTTP protocol and the Secure Socket Layer (SSL) encryption protocol.

Data storage device 390 also stores client template database 394, bidder database 396 and bid database 398. Client template database 394 includes information relating to completed bid templates received from clients such as an entity operating requestor device 200. Bidder database 396 specifies information associated with bidders to whom bid templates may be transmitted and from which bids may be received, and bid database 398 associates completed bid templates with bids and bidders. The completed bid templates described in client template database 394 and the bids described in bid database 398 are stored among template and bid data files 399 of data storage device 390. Data storage device 390 may also store one or more of terms and conditions documents, provider engagement letters, provider policies and cost-savings agreements for transmission to bidders.

Also stored in data storage device 390 may be other unshown elements that may be necessary for operation of bidding management device 300. These elements may include an operating system such as Microsoft Windows 2000™, a database management system such as MS-SQL 7.0 with ODBC driver, a backup application, other applications, other data files, and “device drivers” for allowing microprocessors 310 to interface with devices in communication with communication port 330. These elements are known to those skilled in the art, and are therefore not described in detail herein.

### Bidder Device

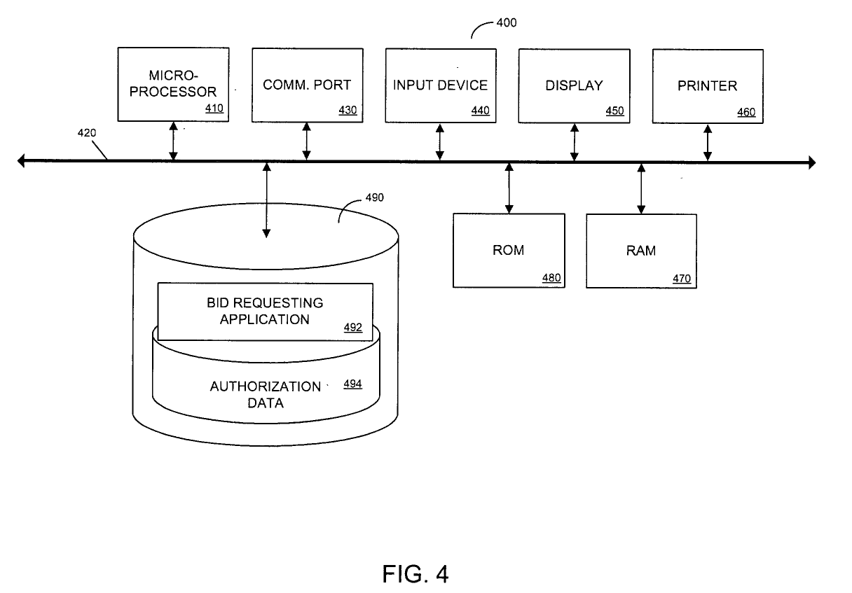

FIG. 4 illustrates several components of bidder device 400 according to some embodiments of the invention. As briefly described above, communication port 430 may be used to receive bid templates from bidding management device 300 and to transmit bids thereto. In this regard, input device 440 may be used by a bidding entity to input bid information into a bid template presented by display 450 and to input commands for transmitting the bid template to bidding management device 300. Bidder device 400 may also be used to output a hardcopy of a bid template including bid information via printer 460. Input device 440, display 450 and printer 460 may comprise any of those devices described above and may be used in conjunction with other applications provided by bidder device 400 which are unrelated to the present invention.

According to some embodiments, the bid information includes a number of work hours associated with each provider level specified in the bid template. As described above, a bid template may include an estimated number of work hours for each provider level. A bidder may consider the estimated number of work hours when formulating a number of work hours to associate with a provider level. The total bid price is equal to the number of work hours associated with each provider level multiplied by the billing rate for each provider level specified in the bid template.

Storage device 490 of bidder device 400 stores processor-executable process steps of Web client 492. The process steps may be executed by microprocessor 410 to allow communication with Web servers such as a Web server provided by bidding server application 392 of device 300. Authorization data 494 includes information that is transmitted to bidding management device 300 to allow determination of whether an entity operating bidder device 400 is authorized to receive a requested completed bid template. The information stored in authorization data 494 may comprise Web cookies. Storage device 490 may also store one or more of other applications, data files, device drivers and operating system files needed to provide functions related and unrelated to the present invention.

### Databases

A tabular representation of a portion of template information database 292 is shown in FIG. 5. As described above, the information stored in template information database 292 describes bid templates that may be used by a requestor to define a project. More specifically, the bid templates may be used to associate a project with a first number of work hours and a first billing rate for a first provider level, and with a second number of work hours and a second billing rate for a second provider level.

Template information database 292 of FIG. 4 includes several records, each consisting of several fields. The fields include template Id field 501, name field 502, location field 503, owner field 504, and formal document set field 505. Template Id field 501 includes an identifier that identifies a particular bid template. Name field 502 includes a brief description of a bid template. In most cases it will be more efficient for a requestor to identify a bid template by its name rather than its template Id.

Location field 503 specifies a location of an associated bid template. The location may be specified in any format, including a network address, a Uniform Resource Locator, a filepath, or the like. In some embodiments, a filepath specified in location field 503 points to files stored within templates 294. Owner field 504 identifies the “owner” of an associated template. The owner may have any particular connection to or responsibility for the associated template. For example, the owner may be an entity that has one or more of the following characteristics: created the template; possesses sole authority to edit the template; must be notified if the template is to be changed; must provide permission before the template is edited; and any other characteristic.

Formal document set field 505 specifies a set of documents comprising one or more terms and conditions documents, provider engagement letters, provider policies, and cost-saving agreements associated with a bid template. By associating a bid template with a formal document set, some embodiments facilitate efficient implementation of an auction.

The information stored in template information database 292, as well as that stored in each other of the databases of requester device 200, may be received from an operator of input device 240, via communication port 230, and from other devices in communication with requester device 200. In some embodiments, template information database 292 is updated each time a bid template is added to an intranet to which requester device 200 belongs.

FIG. 6 illustrates a tabular representation of a portion of fee database 293. Fee database 293 includes historical billing information such as historical billing rates associated with various service providers. The information may be collected from invoices received from service providers or otherwise received by an entity operating requestor device 200. For example, requestor device 200 may subscribe to a service that provides such billing information for various service providers. The information of fee database 293 may be used to generate bid templates including billing rates for various provider levels and to evaluate a plurality of received bids.

Within a record of fee database 293, date field 601 identifies a date of an invoice that is represented by the record. Firm field 602 specifies a service provider that issued the invoice and whose billing information is reflected in the record. In the present example according to some embodiments of the invention, the service provider is a law firm and the provided services are legal services. Project field 603 identifies a project for which the associated record provides billing information. It should be noted that a single invoice may be associated with more than one project. Accordingly, in some embodiments, information included within several records of database 293 may be collected from a single invoice.

Senior partner rate field 604, junior partner rate field 605, senior associate rate field 606 and junior associate rate field 607 specify the billing rates of senior partners, junior partners, senior associates and junior associates, respectively, for an associated project. In some embodiments, fee database 293 includes a separate field for each attorney that worked on a project. Of course, fee database 293 may include other fields that specify other billing-related information, including billing rates of and hours worked by other workers such as paralegals, a blended billing rate composed of two or more associated billing rates, an effective overall billing rate, a total project cost, a time to complete project, an estimated project budget, or the like.

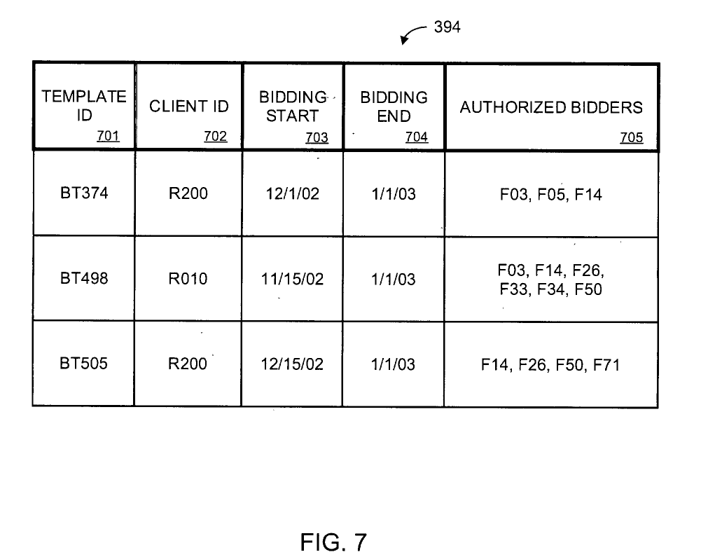

A tabular representation of a portion of client template database 394 of data storage device 390 is shown in FIG. 7. Client template database 394 provides details relating to completed bid templates that are received by bidding management device 300 from requestor device 200 and/or other devices. The details are specified in template Id field 701, client Id field 702, bidding start field 703, bidding end field 704 and authorized bidders field 705.

Template Id field 701 of a record specifies an identifier of a received completed bid template. The identifiers correspond to a completed bid template stored in template and bid data files 399. It should be noted that two different completed bid templates that are identified by different identifiers in client template database 394 may be based on a same bid template.

Client Id field 702 of the record identifies a client from whom the completed bid template was received. The client may be an operator of a device used to transmit the completed bid template and/or an entity employing or otherwise directing the operator. Bidding start field 703 and bidding end field 704 specify dates on which the submission of bids based on the completed bid template will start and end. The dates may be specified by the client during submission of the completed bid template, and may also be specified by the entity operating bidding management device 300. The client or the operating entity may also specify the identifiers included in authorized bidders field 705. These identifiers indicate service providers who are authorized to submit bids associated with the completed bid template of the record. The identifiers may correspond to the set of identifiers used in firm field 602 of fee database 293 or may be unrelated to this set of identifiers.

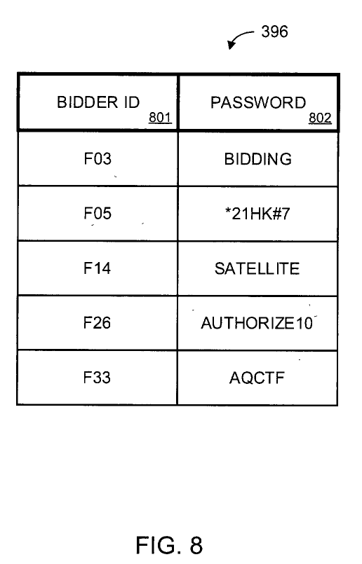

The tabular portion of bidder database 396 illustrated in FIG. 8 stores information used to verify a potential bidder's identity. In particular, each record of bidder database 396 associates a bidder Id in bidder Id field 801 with a password in password Id field 802. Of course, other information may be included in bidder database 396 to verify a potential bidder's identity, such as a username. Moreover, a single bidder Id may be associated with more than one password and/or other verification information.

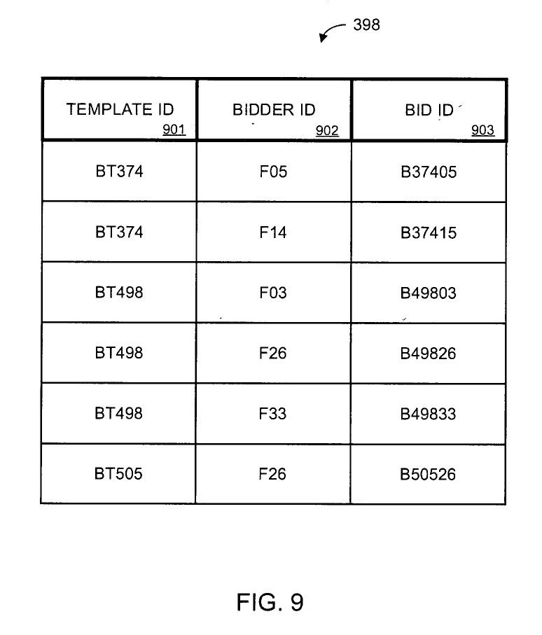

FIG. 9 illustrates a tabular representation of a portion of bid database 398. As shown, each record of bid database 398 associates a completed bid template with a bidder and a bid. More specifically, each record of bid database 398 includes template Id field 901 identifying a completed bid template, bidder Id field 902 identifying a bidder who has submitted a bid based on the completed bid template, and bid Id field 903 identifying the bid. The identified bid is stored among template and bid data files 399.

It should be noted that the illustrations and accompanying descriptions of databases included herein merely represent relationships between stored information. A number of other arrangements may be employed besides those suggested, including arrangements in which some or all of the specified data is located remote from the device in which it is described above as being stored. It is further contemplated that each of the databases may include many more records than those shown and that each record may include associated fields other than those illustrated. Also, one or more of the databases may be substituted with a conventional paper-based filing system.

### Process Flow

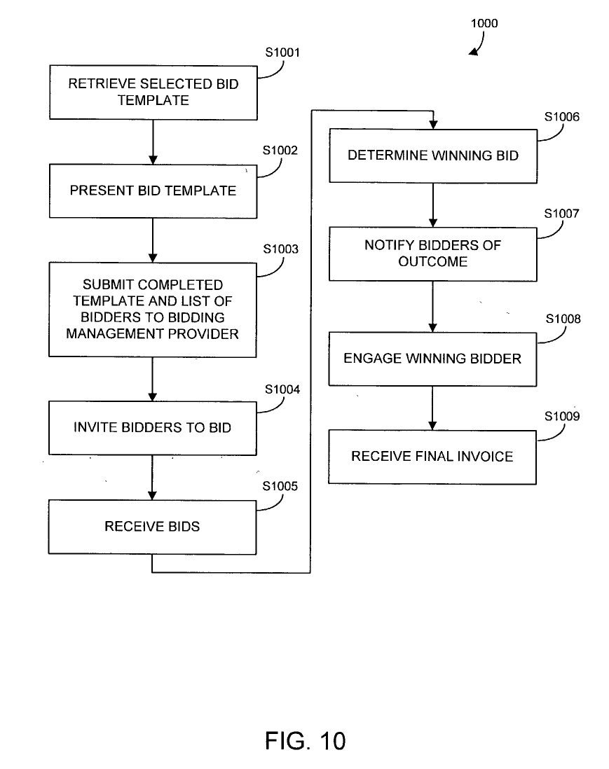

FIG. 10 comprises a flow diagram of process steps 1000 for project bidding according to some embodiments of the invention. Process steps 1000 are described below as being executed by hardware and/or software of requester device 200 and bidding management device 300. However, process steps 1000 may be embodied in and executed by any number or type of devices, alone or in any combination.

Initially, in step S1001, a selected bid template is retrieved by requester device 200. In some embodiments of step S1001, requester device 200 executes bid requesting application 291 to present an interface to a bid requester via display 250. The interface may include data such as that stored in template information database 292. The requestor manipulates the interface to select an appropriate bid template and the selected bid template is retrieved by requester device 200. The selected template may be tailored to a particular type of project for which a bid is desired. The template may be retrieved from templates 294 or from any other repository of templates to which requester device 200 has access based on information associated with the template in corresponding location field 503 of database 292.

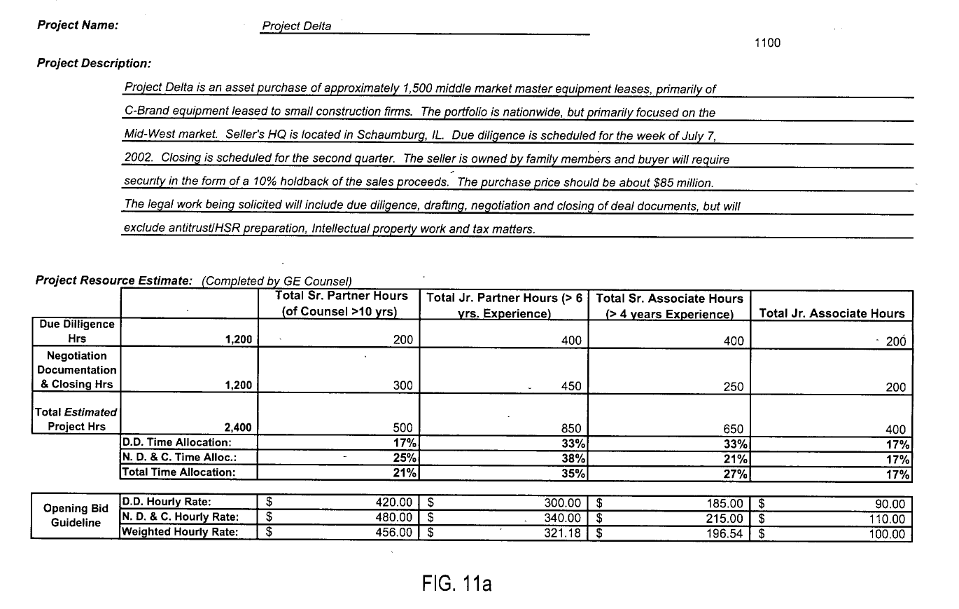

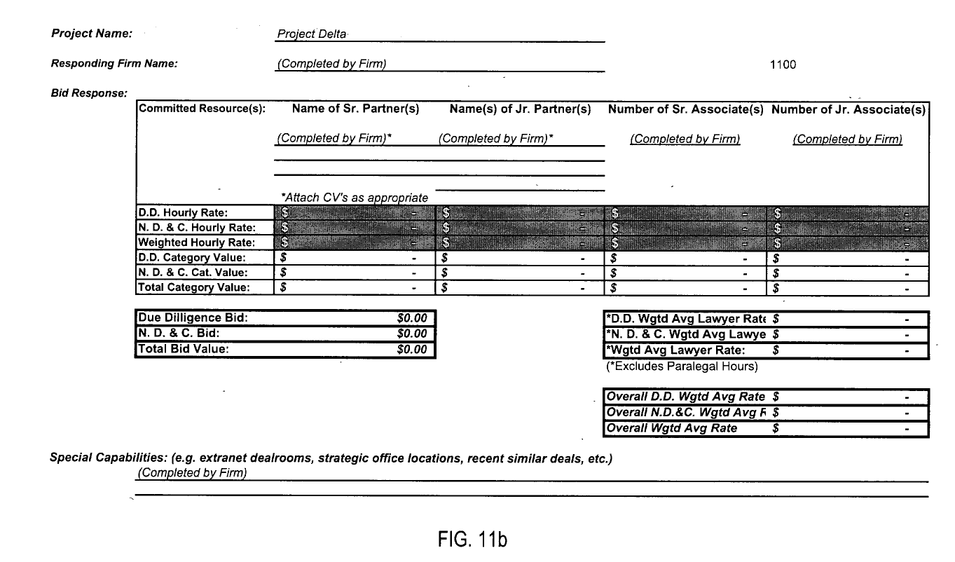

The retrieved bid template is presented to the requestor in step S1002. The requester then completes the template by using input device 240 to enter data into areas of the presented bid template. FIGS. 11a and 11b illustrate a completed bid template according to some embodiments of the invention. As shown, completed template 1100 of FIG. 11a includes a project name area, a project description area and a project resource estimate area that are completed by the operator. Data entered in the project description area is intended to provide a description of the associated project based on which a potential bidder can formulate an accurate bid. Similarly, data entered into project resource estimate area is intended to provide even further guidance to a potential bidder.

The data entered into project resource estimate area may be based on information stored in fee database 293 or on other historical billing information to which the operator and/or requester device 200 has access. In this regard, bid requesting application 291 may include process steps to automatically complete some or all of the project resource estimate area based on stored billing information. It should be noted that project resource estimate area of template 1100 includes a first area for indicating, for a first project, a first number of work hours and a first billing rate for a first provider level, as well as a second area for indicating, for the first project, a second number of work hours and a second billing rate for a second provider level. Template 1100 also includes a third area for indicating, for a second project, a third billing rate for the first provider level, and a fourth area for indicating, for the second project, a fourth number of work hours and a fourth billing rate for the second provider level. The first project and the second project are sub-projects of a third project, and some embodiments may provide for three or more sub-projects within a single bid template.

The areas of template 1100 shown in FIG. 11b are to be completed by a bidder. These areas include a bid response area that includes a fifth area for indicating, for the first project, a fifth billing rate for the first provider level, and a sixth area for indicating, for the first project, a sixth billing rate for the second provider level. Additionally, template 1100 of FIG. 11b includes a seventh area for indicating, for the second project, a seventh billing rate for the first provider level, and an eighth area for indicating, for the second project, an eighth billing rate for the second provider level. The fifth through eighth areas correspond to respective ones of the first through fourth areas described above.

According to some embodiments, the template 1100 of FIG. 11b cues a bidder while the bidder inputs provider billing rates into the bid response area. For example, the bidder may enter a billing rate for the first provider level into a cell of the bid response area. If the entered billing rate is lower than the corresponding billing rate for the first provider level entered in the project resource estimate area, the cell is colored green. If the entered rate is lower or equal to the corresponding billing rate, the cell is colored red and gray, respectively. The bid response area may provide any other methods for indicating a quantitative relationship between a proposed billing rate and a bid billing rate.

Bid template 1100 also includes a special capabilities area for describing any special considerations to be taken into account when evaluating an associated bid. These special considerations may include staffing capabilities, available technological resources and other factors that a bidder would like to have considered during evaluation of its bid.

Template 1100 results in more-easily evaluated bids by segmenting a project into multiple sub-projects and soliciting bids based on an allocation of work hours for each sub-project. For example, a bid price will depend on an amount and an allocation of work hours among provider levels because billing rates for each provider level are fixed by the bid template. Further comparison criteria will be described below. In addition, re-bidding and/or price negotiations might not be necessary in a case that the bid requester decides to proceed with less than all of the sub-projects.

In step S1003, the completed template and a list of authorized bidders is submitted to bidding management device 300. According to some embodiments, requestor device 200 executes process steps of a Web browser in order to present a Web browser window on display 250. The requester enters a Uniform Resource Locator (URL) into the window corresponding to a Web server executed by bidding management device 300. Accordingly, a request is transmitted to bidding management device 300 and a Web page is transmitted in response to requestor device 200. The Web page requests login information from the requestor. After the appropriate login information is submitted, a Web page is transmitted to requestor device 200 using which the requestor may submit the completed template and list of bidders. Of course, other suitable methods for exchanging data between devices may be used in step S1003.

The information received by bidding management device 300 is stored in client template database 394. Specifically, bidding management device 300 associates an Id under which the completed template is stored in templates and bid data files 399, an Id identifying the requester from whom the template was received, and the list of authorized bidders. In the present example, bidding management device 300 also associates the foregoing information with a bidding start date and a bidding end date which were also received from requester device 200 in step S1003.

Next, in step S1004, bidding management device 300 transmits an invitation to all authorized bidders notifying them of the requested bid. In this regard, bidding management device 300 may access a directory that associates bidder Ids with contact information. The invitation may be transmitted before, on, or after the associated bidding start date. The invitation are transmitted in some embodiments by requester device 200 or by another device operated by the requestor. Bids are then received from one or more of the authorized bidders in step S1005.

The process of receiving bids may occur in many ways according to some embodiments of the invention. In one example, a bidder operating bidder device 400 accesses a Web server of bidding management device 300 by executing process steps of Web client 492 and by inputting an appropriate URL as described above. A bidder Id and password from authorization data 494 are passed to the Web server, where they are compared against corresponding information specified in bidder database 396. If the bidder's identity is verified, the bidder is presented with a Web page including links to all templates for which the bidder is authorized to submit a bid. The bidder then operates input device 440 to select a template, to complete the bid areas of the selected template, and to transmit the completed bid areas to bidding management device 300. The received bids may be stored among template and bid data files 399 of bidding management device 300. Moreover, each received bid is assigned a bid Id which is associated in bid database 398 with the bidder from whom the bid was received and the bid template corresponding to the bid.

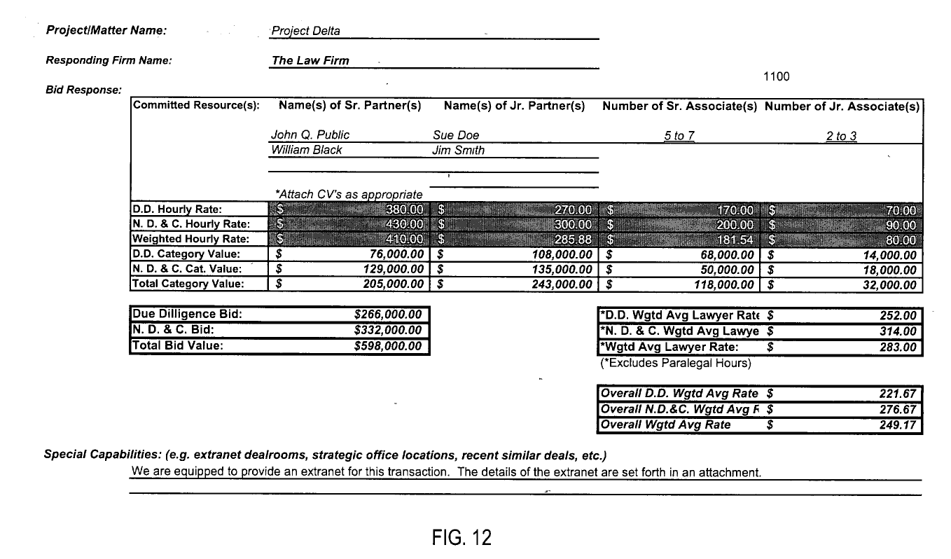

FIG. 12 illustrates the bid areas of template 1100 as completed by an authorized bidder. It should be noted that the template presented to the bidder need not be identical to the template completed by the requestor and/or submitted to bidding management device 300. In some embodiments, it is only required that the bids received in step S1005 include some or all of the information requested in the submitted completed bid template.

In some embodiments, bidders may submit questions to the requestor and receive answers therefrom prior to submitting a bid. The questions and answers may be transmitted directly between a bidder and a requestor or may be passed through bidding management device 300. Each question and answer may be private or transmitted to each authorized bidder. In this regard, bidding management device 300 may conduct question and answer forums at specified times during the bidding process.

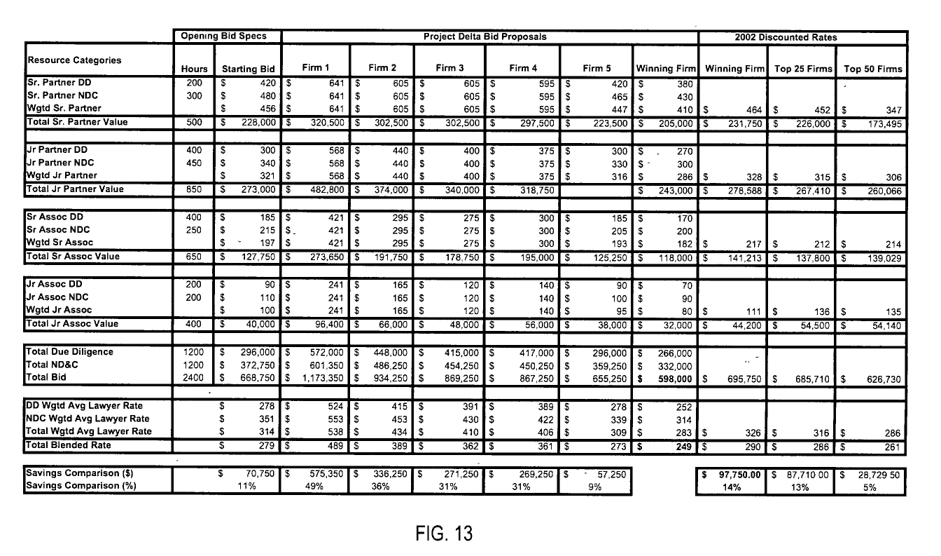

A winning bid is determined in step S1006 after the end date specified in bidding end field 704. The determination of step S1006 may be performed by bidding management server 300, by requester device 200, or by another device. FIG. 13 illustrates chart 1300 used in conjunction with some embodiments to determine a winning bid. As shown, chart 1300 compiles details of the completed bid template, received bids and historical billing rate information. The historical billing rate information includes historical billing rates of one bidder as well as averaged historical billing rates of two or more bidders. Chart 1300 also includes a total blended billing rate reflected in each received bid. The total blended billing rate for each bid is a combination of a number of hours attributed to each provider level by a bidder weighted by a billing rate specified for each provider level. Any of the information shown in chart 1300 may be used to determine a winning bid in step S1006. The information specified in the special capabilities area of each bid may also be taken into consideration.

In some embodiments, flow returns to step S1004 from step S1006 to conduct an additional round of bidding in a case that the requestor desires revised bids, additional information, or the like. The additional round of bidding may be open to any combination of the original authorized bidders, the original actual bidders, and/or other bidders.

Bidders are notified of the winning bid in step S1007. This notification may occur in any suitable manner. In some embodiments, requestor device 200 identifies the winning bid to bidding management device 300 and device 300 transmits the notification in an electronic mail message to all bidders that submitted bids. Of course, any or all of the authorized bidders may be notified in step S1007, and the notification may include some, all or no details of the winning bid.

Next, in step S1008, the requester engages the services of the winning bidder. According to some embodiments, template information database 292 is used to determine an identifier of a formal document set associated with the subject bid template. The identifier is then used to retrieve one or more of a terms and conditions document, a provider engagement letter, a provider policy and a cost-savings agreement from formal document sets 295. In one example, the terms and conditions document indicates that the services are to be provided according to the billing rates specified by the winning bidder in the bid response area of bid template 1100. As described above, the engagement letter may form a binding agreement between the parties, and the policy may specify general operational policies that service providers are expected to follow.

The retrieved documents are transmitted to the winning bidder so as to establish an agreement that reflects the terms of the completed bid template and the submitted bid. The agreement may be established electronically, through bidding management device 300, and/or through traditional signed contracts. The winning bidder renders the bid-for services according to the agreement prior to step S1009.

A final invoice for the services is received by the requestor in step S1010. The final invoice may reflect the services specified in the completed bid template and may indicate an amount due corresponding to the submitted bid. The invoice may include additions and reductions agreed to by the requester and the bidder. For example, the invoice may reflect only services rendered in relation to a sub-project of the completed bid template. If the sub-project was treated individually as in the completed bid template of the present example, an invoice that accurately reflects the bid may be more easily created than in other cases.

Additions or reductions may be calculated based on a cost-saving agreement between the parties. For example, if the effective billing rate (total price/total hours) is less than a blended billing rate computed from the winning bid, the parties may be bound to divide the resulting cost savings. In some embodiments, the magnitude of the cost savings determines the relative proportions received by each party. The proportion of cost savings received by the winning bidder may increase as the cost savings increase, thereby further encouraging the winning bidder to allocate work hours to a provider level that is associated with a lowest billing rate.

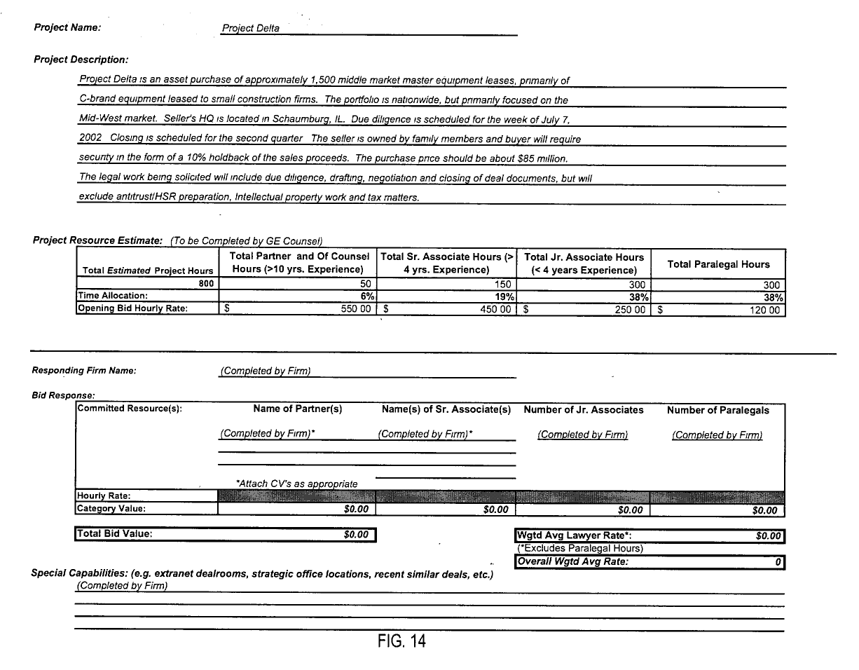

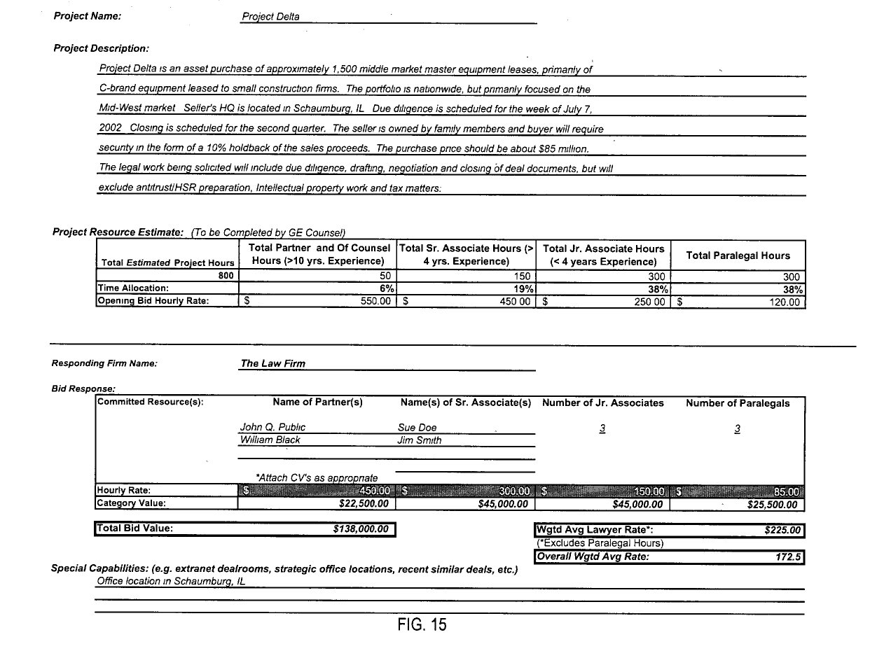

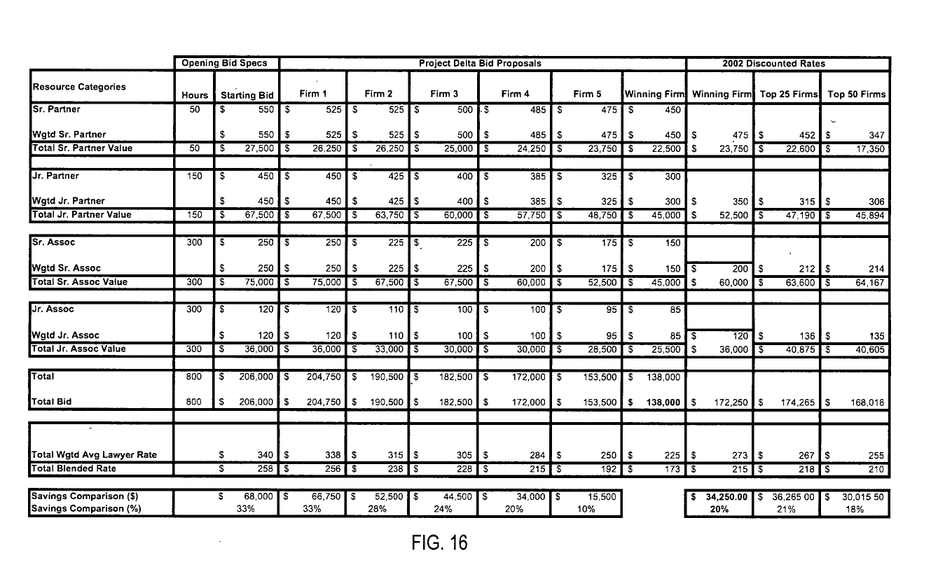

FIGS. 14 through 16 respectively illustrate a completed bid template, a bid, and a comparison chart according to some embodiments of the present invention. Unlike FIGS. 11 through 13, FIGS. 14 through 16 do not segment a project into more than one sub-project. FIGS. 14 through 16 are therefore included to indicate that many types of bid templates may be used for a particular project. In this regard, each of the bid templates described herein may be altered to specify a fixed-price auction, in which bidders are asked to submit a total price for a specified project.

The particular arrangement of process steps 1000 is not meant to imply a fixed order to the steps; embodiments of the present invention can be practiced in any order that is practicable. Moreover, process steps 1000 may be altered to create embodiments of the invention completely or partially different from any of the arrangements mentioned herein without departing from the spirit and scope of the present invention.

What is claimed is:

1. A modular toolkit comprising:
a bid template for specifying bidding parameters for a project;
a terms and conditions document;
a provider engagement letter; and
a provider policy.

2. A modular toolkit according to claim 1, the bid template comprising:
a first area for indicating, for a first project, a first number of work hours and a first billing rate for a first provider level; and
a second area for indicating, for the first project, a second number of work hours and a second billing rate for a second provider level.

3. A modular toolkit according to claim 2, wherein the first project and the second project are sub-projects of a third project.

4. A modular toolkit according to claim 2, the bid template comprising:
a third area for indicating a first bid billing rate for the first provider level; and
a fourth area for indicating a second bid billing rate for the second provider level.

5. A modular toolkit according to claim 4, the third area for indicating to a bidder a quantitative relationship between the first billing rate and the first bid billing rate, and the fourth area for indicating to a bidder a quantitative relationship between the second billing rate and the second bid billing rate.

6. A modular toolkit according to claim 1, further comprising:
a cost-saving agreement for dividing a difference between a bid blended billing rate and an actual blended billing rate between a bid requester and a winning bidder.

7. A modular toolkit according to claim 1, the bid template comprising:
an area for indicating special considerations related to the project.

8. A method usable in conjunction with project bidding, comprising:
associating a project with a first number of work hours and a first billing rate for a first provider level, and with a second number of work hours and a second billing rate for a second provider level;
transmitting the associations to a plurality of potential bidders; and
receiving a plurality of bids for the project from the plurality of potential bidders, one or more of the plurality of bids including a third billing rate for the first provider level, and a fourth billing rate for the second provider level.

9. A method according to claim 8, further comprising:
determining a winning bid from the plurality of bids based on one or more of a total blended billing rate, historical billing rates of one bidder, and historical billing rates of two or more bidders.

10. A method according to claim 8, wherein the first provider level comprises a first attorney level and wherein the second provider level comprises a second attorney level.

11. A method according to claim 8, wherein the associating step comprises:
identifying a bid template for the project; and
inputting the first number of work hours, the first billing rate, the second number of work hours, and a second billing rate into the bid template.

12. A method usable in conjunction with project bidding, comprising:
receiving a plurality of bids; and
determining a winning bid from the plurality of bids based on a total blended billing rate, historical billing rates of a single bidder, and/or historical billing rates of two or more bidders.

13. A computer-readable medium storing executable process steps, the process steps comprising:
a step to associate a project with a first number of work hours and a first billing rate for a first provider level, and with a second number of work hours and a second billing rate for a second provider level;
a step to transmit the associations to a plurality of potential bidders; and
a step to receive a plurality of bids for the project from the plurality of potential bidders, one or more of the plurality of bids including a third billing rate for the first provider level, and a fourth billing rate for the second provider level.

14. A medium according to claim 13, further comprising:
a step to determine a winning bid from the plurality of bids based on one or more of a total blended billing rate, historical billing rates of one bidder, and historical billing rates of two or more bidders.

15. A medium according to claim 13, wherein the first provider level comprises a first attorney level and wherein the second provider level comprises a second attorney level.

16. A medium according to claim 13, wherein the associating step comprises:
a step to identify a bid template for the project; and
a step to input the first number of work hours, the first billing rate, the second number of work hours, and a second billing rate into the bid template.

17. A computer-readable medium storing executable process steps, the process steps comprising:
a step to receive a plurality of bids; and
a step to determine a winning bid from the plurality of bids based on a total blended billing rate, historical billing rates of a single bidder, and/or historical billing rates of two or more bidders.

18. A device comprising:
a processor; and
a storage device in communication with the processor and storing instructions adapted to be executed by the processor to:
associate a project with a first number of work hours and a first billing rate for a first provider level, and with a second number of work hours and a second billing rate for a second provider level;
transmit the associations to a plurality of potential bidders; and
receive a plurality of bids for the project from the plurality of potential bidders, one or more of the plurality of bids including a third billing rate for the first provider level, and a fourth billing rate for the second provider level.

19. A device according to claim 18, the stored instructions further adapted to be executed by the processor to:
determine a winning bid from the plurality of bids based on one or more of a total blended billing rate, historical billing rates of one bidder, and historical billing rates of two or more bidders.

20. A device according to claim 18, wherein the first provider level comprises a first attorney level and wherein the second provider level comprises a second attorney level.

21. A device according to claim 18, wherein the association step comprises:
identification of a bid template for the project; and
input of the first number of work hours, the first billing rate, the second number of work hours, and a second billing rate into the bid template.

22. A device comprising:
a processor; and
a storage device in communication with the processor and storing instructions adapted to be executed by the processor to:
receive a plurality of bids; and
determine a winning bid from the plurality of bids based on a total blended billing rate, historical billing rates of a single bidder, and/or historical billing rates of two or more bidders.

23. A system comprising:
a requestor device for associating a project with a first number of work hours and a first billing rate for a first provider level, and with a second number of work hours and a second billing rate for a second provider level;
a bidding management device for receiving the associations, for transmitting the associations to bidder devices, for receiving bids from the bidder devices, and for transmitting the bids to the requestor device.

24. A system according to claim 23, wherein the bidding management device determines a winning bid from the bids based on one or more of a total blended billing rate, historical billing rates of one bidder, and historical billing rates of two or more bidders.

25. A system according to claim 23, wherein the requestor device determines a winning bid from the bids based on one or more of a total blended billing rate, historical billing rates of one bidder, and historical billing rates of two or more bidders.

26. A bid template, comprising:
a first area for indicating, for a first project, a first number of work hours and a first billing rate for a first provider level; and
a second area for indicating, for the first project, a second number of work hours and a second billing rate for a second provider level.

27. A bid template according to claim 26, further comprising:
a third area for indicating, for a second project, a third number of work hours and a third billing rate for the first provider level; and
a fourth area for indicating, for the second project, a fourth number of work hours and a fourth billing rate for the second provider level.

28. A bid template according to claim 27, wherein the first project and the second project are sub-projects of a third project.

29. A bid template according to claim 27, wherein the first billing rate and the third billing rate are identical, and
wherein the second billing rate and the fourth billing rate are identical.

30. A bid template according to claim 26, further comprising:
a third area for indicating, for the first project, a third billing rate for the first provider level; and
a fourth area for indicating, for the first project, a fourth billing rate for the second provider level.

31. A bid template according to claim 30, wherein the first area and the second area are completed by a bid requester, and
wherein the third area and fourth area are completed by a bidder.
